(19) United States
(12) Patent Application Publication
(10) Pub. No.: US 2008/0165243 A1
(43) Pub. Date: Jul. 10, 2008

(54) PRINT HEAD INCLUDING AN ORGANIC LIGHT EMITTING DEVICE

(75) Inventors: Jong-Seok Oh, Suwon-si (KR); Jong-hyuk Lee, Suwon-si (KR); Young-Woo Song, Suwon-si (KR); Kyu-Hwan Hwang, Suwon-si (KR); Joon-Gu Lee, Suwon-si (KR); Jae-Heung Ha, Suwon-si (KR); Chul-Woo Park, Suwon-si (KR)

Correspondence Address: CHRISTIE, PARKER & HALE, LLP, PO BOX 7068, PASADENA, CA, 91109-7068, US

(73) Assignee: SAMSUNG SDI CO., LTD., Suwon-si (KR)

(21) Appl. No.: 11/854,459

(22) Filed: Sep. 12, 2007

(30) Foreign Application Priority Data
Jan. 9, 2007 (KR) 10-2007-0002662

(51) Int. Cl. B41J 2/45; H01J 1/62

(52) U.S. Cl. 347/238; 313/504

(57) ABSTRACT

A print head includes a light source, a driver chip electrically connected to the light source and a lens array on the side of light irradiation of the light source. The light source includes a substrate and a plurality of organic light emitting diodes arranged in adjacent groups on the substrate. Each of the organic light emitting diodes of a group includes a first electrode, an organic emissive layer, and a second electrode. First wires on the substrate connect each first electrode to a first electrode in an adjacent group. A separator is located between the adjacent groups. A first pad on the substrate is electrically connected to each first electrode of each of the organic light emitting diodes of a first group and a plurality of second pads are located on the substrate, each second pad electrically connected to the second electrode of each group.

### CROSS-REFERENCE TO RELATED PATENT APPLICATION

This application claims priority to and the benefit of Korean Patent Application No. 10-2007-0002662, filed on Jan. 9, 2007, in the Korean Intellectual Property Office, the entire disclosure of which is incorporated herein by reference.

### BACKGROUND OF THE INVENTION

1. Field of the Invention

The present invention relates to an organic light emitting device for a print head, and more particularly to an organic light emitting device having improved light emission uniformity.

2. Description of the Related Art

Conventional optical print heads used in optical printers are largely categorized into print heads that use a laser beam and a polygon mirror and print heads that use light emitting diode (LED) array chips and driver ICs. Printers using LED print heads are used on a larger scale than print heads using laser beams due to their having no moving parts, optical simplicity, high impact resistance, great width, accurate printing positioning, and configuration simplicity.

In printers using an optical print head having LED chips, a plurality of LED light sources are arranged in a printing direction in LED arrays. The LEDs are selectively activated by an electrical signal according to images to be printed. Light emitted from the light sources are focused onto a photoreceptor by a lens system to form an electrostatic image. Then, toner is applied to the electrostatic image using a developer, and the toner is transferred onto paper by a transferring unit. The lens system generally includes cell width lenses including an optical system for forming images at a ratio of 1:1. The most common LEDs are of a GaAsP or a GaAlAs type. The LEDs emit near-infrared light at a wavelength of 660-740 nm.

In an optical print head having LED chips, LED chips need to be arranged and fixed on a substrate with an alignment accuracy of ±7 μm to obtain rows of light sources for a practical optical print head. However, problems may occur in the dimensional accuracy of LED chips, their arrangement accuracy when fixed on a substrate, and the like. In addition, light amount emitted by unit light sources of a plurality of LEDs are highly irregular, and a control unit is needed to regulate brightness. For example, to print on A4 paper at 300 dpi, LEDs corresponding to 2,400 dots are required and the irregularity of light emission needs to be ±30% or less. However, these conditions cannot be achieved by only the alignment of LED chips. In general, it has been shown that text needs an alignment accuracy of ±30%, graphics need an alignment accuracy of ±20%, and gray scale expression need an alignment accuracy of ±5%. Therefore, means for reducing irregularity, for example, adjusting a driving current or driving time of every LED, is needed. This increases the cost of the print head.

To address these problems, a structure using organic light emitting diodes (OLEDs) is disclosed in Japanese Patent Laid-Open Publication No. hei 10-35004. In this publication, the position accuracy of a plurality of thin luminous regions formed on a transparent substrate of an OLED is determined by the shape accuracy of the substrate and the size accuracy of transparent electrode patterns formed on the substrate. This can fully satisfy the required alignment, and thus solve the problem of alignment between LED chips. In addition, luminescence distribution between aligned LED chips is improved.

However, in the above publication, a luminous time per pixel is relatively short when operated by time division duplexing. Therefore, the speed of a print head must be reduced in order to generate a sufficient amount of light. In addition, the relatively long length of the anode electrode results in a high resistance along the length of the anode electrode. As a result, a voltage difference occurs between the first pixel and the last pixel, reducing light emission uniformity. In addition, a cathode electrode and a driver IC are connected by wire bonding. Although a pixel pitch of a substrate is 42 μm, a minimum pixel pitch of 80 μm is required due to technical limitations of wire bonding. Therefore, a one-to-one connection is not possible when the cathode electrode and the driver IC are connected because the thickness of the wires is a minimum of 10 μm and the minimum interval between adjacent wires must be at least 70 μm in order to prevent the wires from contacting other wires during a wire bonding process.

### SUMMARY OF THE INVENTION

A print head is provided including a light source, a driver chip electrically connected to the light source and a lens array on the side of light irradiation of the light source. In one exemplary embodiment, the light source includes a substrate and a plurality of organic light emitting diodes arranged in adjacent groups on the substrate. Each of the organic light emitting diodes of a group may include a first electrode, an organic emissive layer, and a second electrode. First wires on the substrate connect each first electrode to a first electrode in an adjacent group. A separator may be located between the adjacent groups. A first pad on the substrate may be electrically connected to each first electrode of each of the organic light emitting diodes of a first group and a plurality of second pads are located on the substrate, each second pad electrically connected to the second electrode of each group.

An insulating layer may be located on the substrate covering the first electrodes and first wires and the insulating layer may include a plurality of openings. An OLED may be placed in each opening.

In another exemplary embodiment of the present invention, a printer device is provided including a photoreceptor, a head for irradiating light from a light source on the photoreceptor, a developer for developing toner on the photoreceptor, and a transferring unit for transferring the toner to a material to be printed.

### BRIEF DESCRIPTION OF THE DRAWINGS

FIG. 1 is a cross-sectional view of an organic light emitting device according to an embodiment of the present invention.

FIG. 2 is a schematic plain view of the organic light emitting device of FIG. 1.

FIG. 3 is a cross-sectional view taken along a III-III line of FIG. 2.

FIG. 4 is a cross-sectional view taken along a IV-IV line of FIG. 2.

FIG. 5 is a schematic diagram of a printer device including the organic light emitting device of FIG. 1.

### DETAILED DESCRIPTION

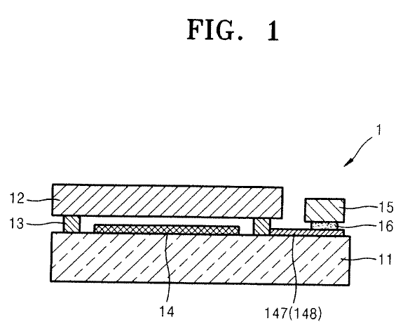

Referring to FIG. 1, the organic light emitting device 1 includes a first substrate 11, a second substrate 12 attached to the first substrate 11 by a sealing material 13, and an organic light emitting unit 14 between the first substrate 11 and the second substrate 12. The first substrate 11 may be glass, plastic, metal or the like, but is not limited thereto. The organic light emitting unit 14 is shielded from exposure to air by the second substrate 12 and the sealing material 13. The second substrate 12 may be glass, plastic, or metal, or metal-based caps, and the sealing material 13 may be an organic sealant as well as an inorganic sealant such as glass frit.

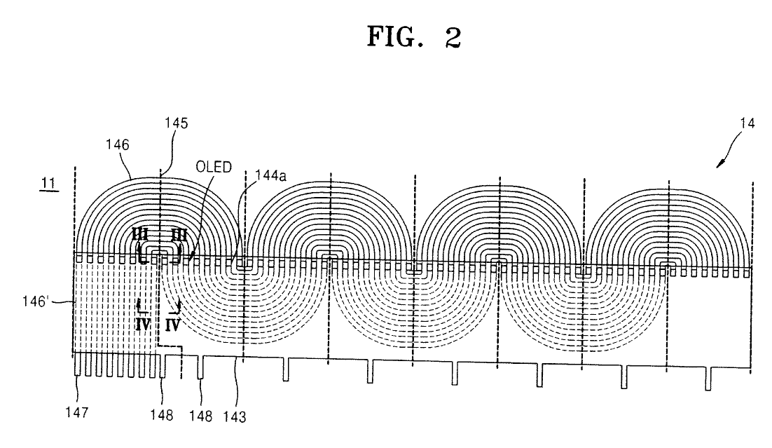

FIG. 2 is a schematic plan view of arrays of OLED of the organic light emitting unit 14. The OLEDs can be arranged linearly in at least two groups. As shown in FIG. 2, eight groups are formed of eight OLEDs each. A separator 145 is located between each of two adjacent groups.

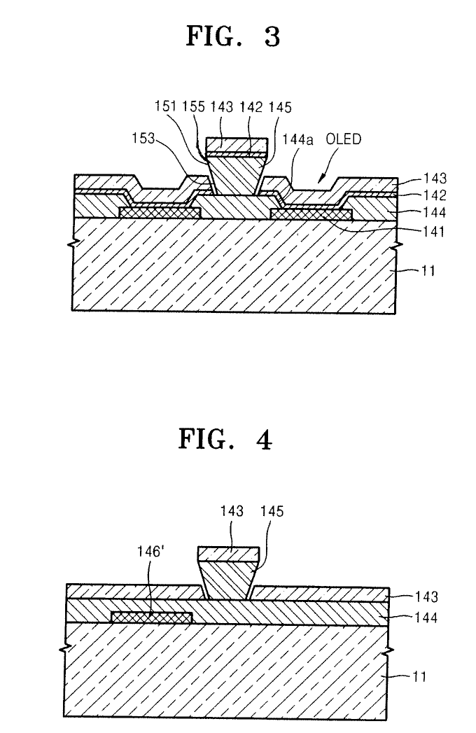

First electrodes of the OLEDs (FIG. 3) in each of the groups are electrically connected by first wires 146. The first wires 146 are each connected such that the OLEDs in each group are symmetrically connected to the OLEDs in the adjacent groups. With reference to FIG. 2, the first OLED from the left of the first group is electrically connected to the first OLED from the right of the second group by one of the first wires 146. Similarly, the second OLED from the left of the first group is electrically connected to the second OLED from the right of the second group by another first wire 146. The rest of the OLEDs of adjacent groups are similarly electrically connected.

First pads 147 are connected to the OLEDs in the first group. Specifically, OLEDs of the first group, which is located on the leftmost side as shown in FIG. 2, are connected to first pads 147 by separate second wires (pad-OLED interconnecting wires) 146′. The first pads 147, first wires 146, second wires 146′ and first electrodes may be formed as one body in one pattern, as described in more detail below.

FIG. 3 is a cross-sectional view taken along line III-III of FIG. 2. Referring to FIG. 3, first electrodes 141 are patterned on a first substrate 11, and insulating layers 144 are formed on the first substrate 11 to cover the first electrodes 141. The insulating layer 144 may cover all the second wires 146′, as illustrated in FIG. 4.

With reference again to FIG. 3, an opening 144a is formed in the insulating layer 144 to correspond to each sub pixel. The separator 145 is formed on the insulating layer 144 to have an overhang structure with outwardly tapering walls 151 extending from a base 153 to a top surface 155, and thus an organic emissive layer 142 and a second electrode 143 are easily patterned on the top surface 155.

As described above, the organic emissive layer 142 and the second electrode 143 of one group are separated from those of an adjacent group by the separator 145. Referring to FIG. 2, although the second electrodes 143 appear to have a continuous shape, in fact, the second electrodes 143 are separated into first and second groups by the separators 145.

Second pads 148 are connected to the second electrodes 143 patterned according to each of the groups. The second electrode 143 and second pads 148 may be made from the same materials, but the process is not limited thereto. In addition, the second pads 148 can be integrally formed with the first pads 147, and the second electrodes 143 can contact the second pads 148.

The first electrodes 141 may be a transparent conductive material, such as ITO, IZO, InOₓ, ZnO or the like, and may be formed to have a pattern using photo lithography. The pattern of the first electrodes 141 may be a plurality of continuous lines connected to the first pads 147 and the first wires 146′, 146. The first electrodes 141 may be transparent electrodes and may function as an anode electrode.

The second electrodes 143 may be a reflective electrode, made from aluminum, silver and/or calcium, and may function as a cathode electrode. The first electrodes 141 and second electrodes 143 may be of opposite polarity.

The organic emissive layer 142 disposed between the first electrodes 141 and the second electrode 143 emits light by electrically driving the first electrodes 141 and the second electrode 143. The organic emissive layers 142 include a hole transport layer, a hole injection layer or the like formed with respect to an emitting layer (EML) towards an anode, and an electron transport layer, an electron injection layer or the like formed with respect to the EML towards a cathode. In addition, the organic emissive layers 142 may include other various layers if necessary.

Non-limiting examples of suitable organic materials for the organic emissive layer are copper phthalocyanine (CuPc), N,N′-Di(naphthalene-1-yl)-N,N′-diphenyl-benzidine (NPB), tris-8-hydroxyquinoline aluminum (Alq3), poly-(2,4)-ethylene-dihydroxy thiophene (PEDOT), polyaniline (PANI), PPV, Soluble PPV's, Cyano-PPV, Polyfluorene.

Light emitted from the organic emissive layers 142 of the OLED is emitted towards the first substrate 11 to produce an image viewable by users on the other side of the lower portion of the first substrate 11.

The OLED may also be formed with a top-emission structure in which light is emitted towards a second substrate 12. In this case, the first electrodes 141 may be reflective electrodes, and the second electrode 143 may be a transparent electrode. The first electrodes 141 may comprise a metal having high reflectivity, such as Al, Ag or the like, and the second electrode 143 is formed of Mg, Ag or the like as a thin film to enable light to be transmitted through the second electrode 143.

When a plurality of OLEDs are arranged in an array as illustrated in FIG. 2, the pads may be spaced by relatively large distances. That is, when the 64 OLEDs illustrated in FIG. 2 operate, the total number of pads used is only 16, including 8 first pads 147 and 8 second pads 148. Therefore, flexibility in the bonding of a driver IC increases.

After the OLEDs are formed as described above, the first pads 147 and the second pads 148 extend along an outer side of the sealing member 13. With reference to FIG. 1, a driver IC 15 is connected to the first pads 147 and the second pads 148. There is no need to connect the driver IC 15 to the pads in a one to one connection. Therefore, the driver IC 15 can be attached to the pads using a conductive adhesive 16 such as an anisotropic conductive film (ACF), or by wire bonding.

The driver IC 15 may comprise a driver IC for a first electrode and a driver IC for a second electrode, separate or integrated. As described above, the driver IC for a first electrode controls sub pixels connected by the first wires 146, and can control the second electrodes 143 separated by the separator 145. When the OLED is operated in this way, there is a sufficient amount of light provided, the first wires 146 prevent a voltage drop, and, as described above, a sufficient pitch can be obtained to allow the driver IC to be directly connected to a substrate in one-to-one connection.

The connection length of the first wires 146 may correspond to a resistance value of up to 10,000Ω, i.e., a wire resistance limit value of a conventional substrate. If the wire resistance of the first wires 146 is 10,000Ω or more, a voltage drop occurs, reducing the overall uniformity of light emission. In addition, the number of sub pixels in one group of the OLEDs is determined by the method of driving a conventional driver IC.

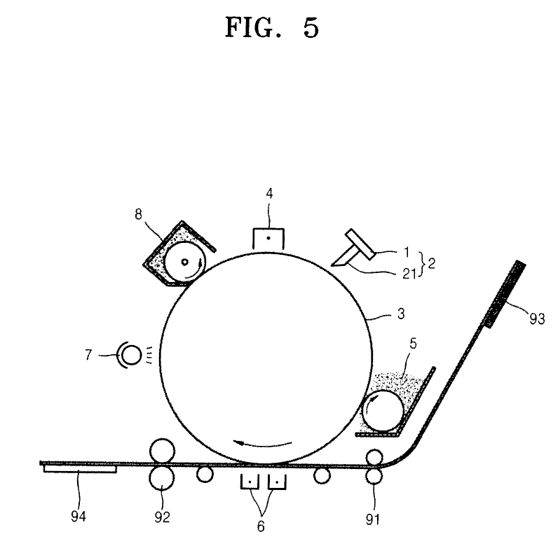

Referring now to FIG. 5, the organic light emitting device 1 may be used in a print head 2 of a printer by arranging a lens array 21 on the front side from which light is emitted. The printer may include a photosensitive drum 3, a charger 4, a developer 5, and a transferring unit 6.

Images to be printed are charged in the charger 4 while the photosensitive drum 3 rotates, and then passed by the print head 2 to be converted to a positive or negative charge on the surface of the photosensitive drum 3. At this time, light emitted from the organic light emitting device 1 is focused on the lens array 21 to form latent images on the photosensitive drum 3. Toner is developed according to the latent image type of the photosensitive drum 3 while the images to be printed are passed by the developer 5. The transferring unit 6 applies toner to paper supplied from a paper cassette 93 by a transfer roller 91. The paper with the toner image is fixed on a fixing unit 92 to be supplied to a receiving cassette 94. The images are removed from the photosensitive drum 3 by a cleaning lamp 7 and a cleaner 8.

According to embodiments of the present invention, pixel groups are connected by first wires and second electrodes are separated by a separator, thus providing a sufficient amount of light, reducing a voltage drop caused by a relatively long substrate, and providing a pitch suitable to connect a driver IC to the OLED.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. An organic light emitting device comprising:
a substrate;
a plurality of organic light emitting diodes arranged in adjacent groups on the substrate,
wherein each of the organic light emitting diodes of a group comprises a first electrode, an organic emissive layer, and a second electrode; and
first wires on the substrate connecting each first electrode to a first electrode in an adjacent group;
a separator between the adjacent groups;
a plurality of first pads on the substrate, each first pad electrically connected to each first electrode of a first group; and
a plurality of second pads on the substrate, each second pad electrically connected to the second electrode of each group.

2. The organic light emitting device of claim 1, wherein the second electrodes of the organic light emitting diodes of each group are integral with each other.

3. The organic light emitting device of claim 1,
wherein the first electrodes of the organic light emitting diodes of each group are arranged linearly; and
wherein the first electrodes of one group are connected by first wires in bilateral symmetry with the first electrodes of an adjacent group.

4. The organic light emitting device of claim 1, wherein the organic light emitting diodes are arranged linearly.

5. The organic light emitting device of claim 1, further comprising an insulating layer on the substrate covering the first electrodes and first wires, the insulating layer comprising a plurality of openings,
wherein an organic light emitting diode is placed in each opening.

6. A print head comprising:
a light source having a light irradiation side;
a driver chip electrically connected to the light source; and
a lens array on the light irradiation side;
wherein the light source comprises:
a substrate;
a plurality of organic light emitting diodes arranged in adjacent groups on the substrate,
wherein each of the organic light emitting diodes of a group comprises a first electrode, an organic emissive layer, and a second electrode; and
first wires on the substrate connecting each first electrode to a first electrode in an adjacent group;
a separator between the adjacent groups;
a plurality of first pads on the substrate, each first pad electrically connected to each first electrode of a first group; and
a plurality of second pads on the substrate, each second pad electrically connected to the second electrode of each group.

7. The print head of claim 6, wherein the second electrodes of the organic light emitting diodes of each group are integral with each other.

8. The print head of claim 6,
wherein the first electrodes of the organic light emitting diodes of each group are arranged linearly; and
wherein the first electrodes of one group are connected by first wires in bilateral symmetry with the first electrodes of an adjacent group.

9. The print head of claim 6, wherein the organic light emitting diodes are arranged linearly.

10. The print head of claim 6, further comprising an insulating layer on the substrate covering the first electrodes and first wires, the insulating layer comprising a plurality of openings,
wherein an organic light emitting diode is placed in each opening.

11. The print head of claim 6, wherein the driver chip is attached to the substrate by a conductive adhesive and is electrically connected to at least one of the first pad and the plurality of second pads.

12. A printer device comprising:
a photosensitive drum having toner;
a head for irradiating light from a light source onto the photosensitive drum;
a developer for developing the toner; and
a transferring unit for transferring the toner to a material to be printed,
wherein the light source comprises:
a substrate;
a plurality of organic light emitting diodes arranged in adjacent groups on the substrate,
wherein each of the organic light emitting diodes of a group comprises a first electrode, an organic emissive layer, and a second electrode; and
first wires on the substrate connecting each first electrode to a first electrode in an adjacent group;
a separator between the adjacent groups;
a plurality of first pads on the substrate, each first pad electrically connected to each first electrode of a first group; and
a plurality of second pads on the substrate, each second pad electrically connected to the second electrode of each group.

13. The printer device of claim 12, wherein the second electrodes of the organic light emitting diodes of each group are integral with each other.

14. The printer device of claim 12,
wherein the first electrodes of the organic light emitting diodes of each group are arranged linearly; and
wherein the first electrodes of one group are connected by first wires in bilateral symmetry with the first electrodes of an adjacent group.

15. The printer device of claim 12, wherein the organic light emitting diodes are arranged linearly.

16. The printer device of claim 12, further comprising an insulating layer on the substrate covering the first electrodes and first wires, the insulating layer comprising a plurality of openings,
wherein an organic light emitting diode is placed each opening.

17. The printer device of claim 12, further comprising a driver chip attached to the substrate by a conductive adhesive and electrically connected to at least one of the first pad and the plurality of second pads.
